(19) United States
(12) Patent Application Publication
(10) Pub. No.: US 2018/0255632 A1
(43) Pub. Date: Sep. 6, 2018

(54) DOWNHOLE FIELD IONIZATION NEUTRON GENERATOR

(71) Applicant: Halliburton Energy Services, Inc., Houston, TX (US)

(72) Inventors: Juan Navarro-Sorroche, Plano, TX (US); Weijun Guo, Houston, TX (US)

(21) Appl. No.: 15/758,288

(22) PCT Filed: Dec. 10, 2015
(86) PCT No.: PCT/US2015/064867

§ 371 Date: Mar. 7, 2018

(51) Int. Cl. H05H 3/06; G01V 5/10

(52) U.S. Cl. CPC H05H 3/06; G01V 5/10

(57) ABSTRACT

A well logging tool includes a neutron generator having a housing, a gas source, a field ionization array, and an extraction ring. The housing defines an ion source chamber, and the gas source delivers ionizable gas to the ion source chamber. The field ionization array directly ionizes the ionizable gas to produce ions in the ion source chamber. The extraction ring produces an ion beam using the ions to initiate a fusion reaction that results in neutron emission from the neutron generator. Additional apparatus, methods, and systems are disclosed.

### BACKGROUND

Pulsed-neutron formation evaluation tools interrogate the formation surrounding the borehole with high-energy neutrons produced by a neutron generator forming part of the tool. Because of interaction by the neutrons with elements of the tool, with the borehole, and with the formation, gamma radiation is created, which is then measured by gamma radiation sensors that also form part of the tool. Measurement data captured by the gamma radiation sensors can be processed to derive information about the properties of the borehole and surrounding subsurface formations.

Some conventional neutron generators can introduce a delay between the application of the ion source voltage and the onset of plasma formation, which increases the ignition time of the ion source. Some conventional neutron sources are costly, use radioactive materials, have low neutron yield, require a large size package, use chemical sources with a short lifetime, and/or have a low porosity sensitivity.

### BRIEF DESCRIPTION OF THE DRAWING

Some embodiments are illustrated by way of example and not limitation in the figures of the accompanying drawings.

FIG. 1 is a schematic sectional side view of a neutron generator, in accordance with some embodiments.

FIG. 2 is a cross-section view of a neutron generator showing a field ionization array, in accordance with some embodiments.

FIG. 3 is another cross-section view of a neutron generator showing a field ionization array, in accordance with some embodiments.

FIG. 4 depicts voltage pulses applied to an ionization grid and an accelerator grid, in accordance with some embodiments.

FIG. 5 is a simplified sectional side view, on an enlarged scale, of a field ionization array, in accordance with some embodiments.

FIG. 6 provides simplified example depictions of plasma surface formation, in accordance with some embodiments.

FIG. 7 is a diagram showing a wireline system that includes a neutron generator, in accordance with some embodiments.

FIG. 8 is a diagram showing a logging while drilling (LWD) system that includes a neutron generator, in accordance with some embodiments.

### DESCRIPTION

An accelerator-based neutron generator includes a field ionization array to produce a high neutron yield (for example, at least approximately 10⁷ neutrons per second (n/s)) using a deuterium-deuterium, (D+D) fusion reaction. In some embodiments, the features of the neutron generator allow it to be dimensioned to fit in a typical 1.69-inch (4.29-centimeter) outside diameter (OD) package used by some operators in the well logging industry. In some embodiments, the neutron generator generates monochromatic 2.5 megaelectron volt (MeV) neutrons. In at least one embodiment, the field ionization array delivers charged particles to an ion source chamber to interact with an ionizable gas (e.g., deuterium gas) to produce ions (e.g., deuterium ions). In some embodiments, an extraction ring extracts the ions to produce an ion beam, and the ions are accelerated toward an ion target carrying target particles (e.g., deuterium atoms) to produce the fusion reaction. In some embodiments, the neutron generator requires high voltage for the fusion reaction to take place, which is supplied by a high voltage multiplier.

Some sources of mono-energetic 14.1 Mev neutrons based on the deuterium-tritium (D+T) fusion reaction have been in use by the well logging industry for over three decades. These D+T neutron generators provide high intensity, high energy neutrons for radiating the earth formations and measuring the results of their interaction with the nuclei in the formations. Elaborate neutron activation analysis techniques are used for elemental formation composition analysis and better characterize the reservoirs. An advantage of using high energy neutrons is that penetration of the radiation into the formation is highest among the neutron sources. However, high energy neutrons exhibit the lowest sensitivity of the near/far (n/f) detector ratio to formation porosity making the accurate estimation of formation porosity difficult. In contrast, neutrons of approximately 2.1 MeV energy such as the one produced by a Cf-252 source, exhibit the largest of the n/f ratio versus porosity sensitivity largely improving the formation porosity estimation.

The n/f ratio sensitivity to porosity for neutrons produced by an AmBe source is reduced by a factor of approximately five at 25-30 percent formation porosity, compared to the sensitivity of a 2.1 MeV (Cf-252) source. The n/f ratio porosity sensitivity for 2.1 MeV neutrons is also orders of magnitude larger than the one exhibited by the 14.1 MeV D+T accelerator neutron source. Thus, the n/f ratio sensitivity to the formation porosity of a 2.5 MeV accelerator neutron source based on the D+D fusion reaction can be orders of magnitude larger than the sensitivity from a 14.1 MeV neutron source.

Because of the low (e.g., 10⁵-10⁶ n/s) neutron yield of conventional neutron generators based on the D+D fusion reaction, D+D neutron generators are not used by the well logging industry as a source of mono-energetic neutrons, using instead the Cf-252 chemical neutron source. Although Cf-252 has orders of magnitude higher specific activity than other chemical neutron sources (such as AmBe), limitation include its short (approximately 2.65 years) half-life, as well as the large cost. Additionally, Cf-252′s larger activity poses a greater environmental impact risk. Having a high output accelerator neutron source of mono-energetic neutrons of 2.5 MeV can therefore improve the formation porosity estimation, as well as eliminating the environmental impact associated with the use of high activity, radioactive chemical neutron source

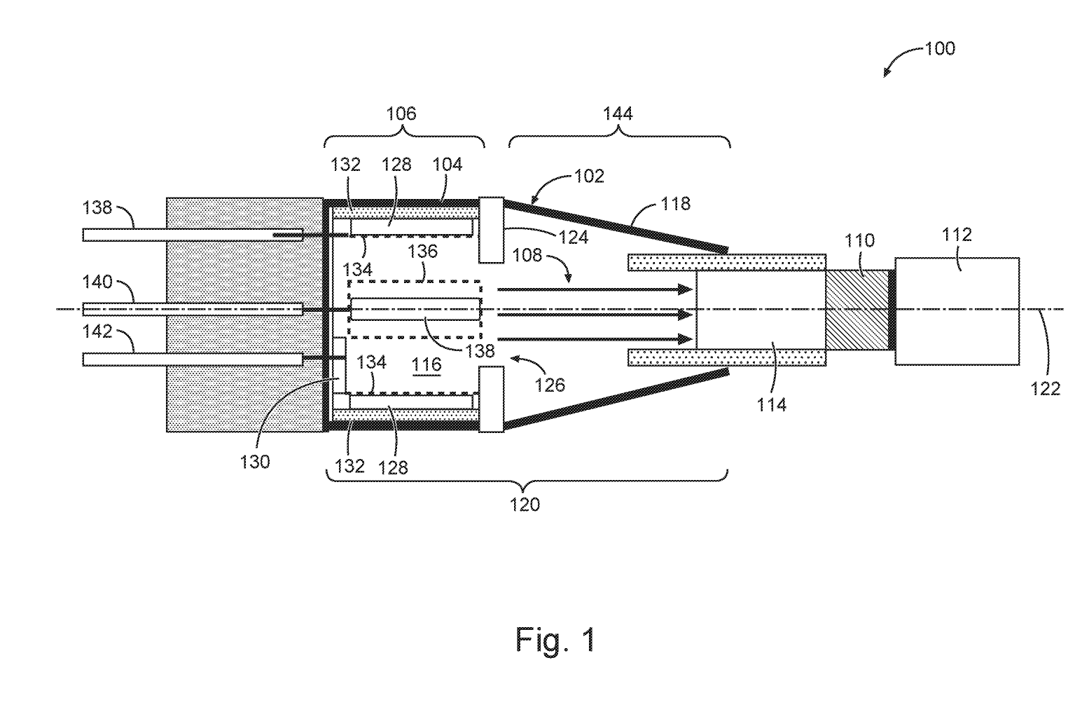

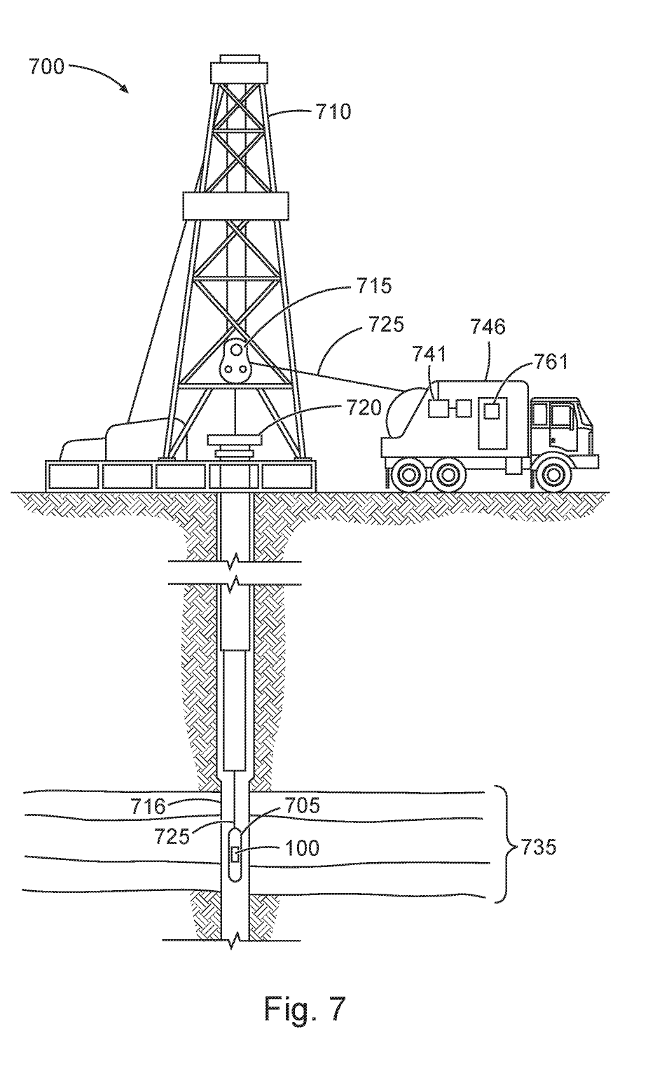

FIG. 1 shows a schematic diagram of a neutron generator 100 in accordance with some embodiments. The neutron generator 100 is configured for incorporation in a logging tool such as the logging tool 705 described with reference to FIG. 7. The neutron generator 100 has an elongate housing 102 dimensioned for fitting longitudinally in a borehole (e.g. the borehole 716 of FIG. 7) with radial clearance. In some embodiments, the housing 102 comprises a hollow cylindrical tube 104 dimensioned for longitudinal insertion in and movement along a borehole of standard size in the industry. In at least one embodiment, the outside diameter of the tool is approximately 1.69 inches (4.29 centimeters). In at least one embodiment, the outside diameter of the tool is less than 1.69 inches (4.29 centimeters). In some embodiments, the tube 104 is of an electrically non-conductive, insulating material, for example being made of alumina ceramic.

The neutron generator 100 includes an ion source 106 for producing positively charged ions that can be extracted from the ion source 106 to form an ion beam 108 directed at a target rod 110 co-axial with the housing 102. In some embodiments, the neutron generator includes a voltage multiplier 112. In the illustrated embodiment, the voltage multiplier 112 is positioned co-axially with the target rod 110 at an end of the target rod 110 furthest from the ion source 106. In some embodiments the voltage multiplier 112 is a high voltage multiplier supplying at least 100 kilovolts (kV) to neutron generator 100. In at least one embodiment, the voltage multiplier 112 is an Ultra High Voltage (UHV) multiplier. In some embodiments, the voltage multiplier 112 provides an electric field for accelerating ions from the ion source 106 toward, and into collision with, the target rod 110.

The target rod 110 includes an ion target 114 disposed on an axial end face of the target rod 110, directed toward the ion source 106. In at least one embodiment, the ion target 114 is circular. The ion target 114 of the target rod 110 carries target particles to form part of the fusion reaction. In some embodiments, the ion target 114 comprises a metal layer doped or saturated with target particles. In at least one embodiment, the target particles carried by the ion target 114 comprise deuterium atoms. When ions of the ion beam 108 collide with target particles in the ion target, energetic neutrons are created. In at least one embodiment, the neutron generator 100 operates to accelerate deuterium ions in the ion beam 108 to collide with deuterium atoms at the ion target 114, to produce a deuterium-deuterium (D+D) fusion reaction. The neutrons escape in random, symmetrical directions from the ion target 114 toward the surrounding environment, which may be a subsurface formation (see, for example FIG. 7). When the neutron generator 100 forms part of a subterranean logging tool, the neutrons are thus ejected into a surrounding formation to enable evaluation of physical characteristics of the subsurface formation.

In the illustrated embodiment, an ion source chamber 116 of the ion source 106 is defined by a cylindrical section of the housing 104, with a frustoconical high-voltage insulator 118 extending between the ion source chamber 116 and the ion target 114. In some embodiments, the housing 102 provides a vacuum envelope 120 which is hermetically sealed and maintained at very low pressure conditions, or at vacuum conditions. In at least one embodiment, the substantially cylindrical ion source chamber 116 is co-axial with a longitudinal axis 122 of the neutron generator 100. In operation, the neutron generator 100 and the tool 705, of which it forms part is inserted in the borehole 716 such that the longitudinal axis 122 extends lengthwise along the borehole 716. In the illustrated embodiment, the ion source chamber 116 has an extraction ring 124 at an end proximate to the ion target 114. The extraction ring 124 defines a central, circular extraction aperture 126 to allow axial passage of accelerated ions from the ion source chamber 116 onto the ion target layer 114.

The ion source 106 is configured to produce positively charged ions by direct ionization. In some embodiments, the ion source 106 includes a field ionization (FI) array 128 to deliver ions, such as deuterium ions, to the ion source chamber 116. The field ionization array directly ionizes ionizable gas (delivered to the ion source chamber 116 by a gas source 130) to produce the ions. In some embodiments, the ionizable gas comprises deuterium gas and the ions comprise deuterium ions. In the illustrated embodiment, the field ionization array 128 is cylindrical and is co-axial with the housing 102. In some embodiments, the field ionization array 128 is distributed along at least a portion of an inner surface of the housing 102. In some embodiments, the ionization array 128 is distributed to at least partially surround a longitudinal axis of the housing 102. In some embodiments, the field ionization array 128 is attached to a radially inner cylindrical surface of the housing 102. In some embodiments, a cylindrical support surface 132 is provided between the housing 102 and the field ionization array 128. In some embodiments, a field ionization grid 134 is co-axial and concentric with the field ionization array 128.

The placement of the field ionization array 128 at the inner surface of the housing 102 allows for a greater surface area of the field ionization array 128 compared to a situation where the field ionization array 128 is disposed at, for example, a circular support surface of a cylindrical disc sharing the axis 122 of the neutron generator 100. In at last one embodiment, the location of the field ionization array 128 increases the active surface area of the field ionization array 128 by approximately one order of magnitude relative to conventional neutron generators. In at least one example, the location of the field ionization array 128 may increase the monatomic D+ ions' density by one order of magnitude relative to conventional neutron generators. The increased surface area of the field ionization array 128 can increase the neutron yield, improve the lifetime of the neutron generator 100, and increase the reliability of the neutron generator 100, relative to conventional neutron generators.

As can be seen in the illustrated embodiment, the field ionization array 128 is not concentric with the target rod 110. Instead, the field ionization array 128 is separated from the ion target 114 of the target rod 110 in an axial direction (of the axis 122 of the neutron generator 100). This allows the deuterium ions produced by the field ionization array 128 in the ion source chamber 116 to be accelerated as an ion beam 108 into an end surface of the ion target 114.

In some embodiments, the ion source 106 includes an ion accelerator 136. The ion accelerator 136 accelerates the ions to form the plasma 138 within the ion chamber 116. In at least one embodiment, the ion accelerator 136 is a high transparency ion accelerator, and the ions oscillate across the high transparency ion accelerator.

In some embodiments, the neutron generator 100 includes an ionization electrode 138 and an accelerator electrode 140. The ionization electrode 138 is in electrical communication with the field ionization grid 134, such that a voltage applied to the ionization electrode 138 sends an electric current to the field ionization grid 134. The accelerator electrode 140 is in electrical communication with the ion accelerator 136, such that a voltage applied to the accelerator electrode 140 sends an electrical current to the ion accelerator 136. By using separate electrodes 138, 140 to separately control these separate functions of the grid and accelerator 134, 136, respectively, additional flexibility is given to the controlling instrument designer to improve the control of the ion source operation, thus improving overall reliability of the neutron generator 100. Additionally, the separation of the ionization electrode 138 and the accelerator electrode 140 provides the mechanism that can be used to control the working gas pressure at the center of the cavity for optimal ion beam emittance. In some embodiments, the neutron generator 100 additionally includes a gas reservoir electrode 142 in electrical communication with the gas source 130.

In at least one example operation of the neutron generator 100, voltage is applied to the gas reservoir electrode 142 to supply the current needed for the gas source 130 to deliver the ionizable gas working pressure. A negative voltage pulse of appropriate amplitude is then applied to the ionization electrode 138 to supply an electrical current to the field ionization grid 134 to create an electric field. Application of the negative voltage pulse to the ionization electrode 138 causes the field ionization array 128 and the field ionization grid 134 to directly ionize the ionizable gas that is in close proximity to the nanotips of the field ionization array 128, to generate ions. In at least one example, the gas source 130 provides deuterium gas to the ion chamber 116, to produce deuterium ions in the ion source chamber 116.

A negative voltage pulse is then applied to the accelerator electrode 140 to supply an electrical current to the ion accelerator 136 to create an electric field to accelerate the ions produced by the field ionization array 128 toward the center of the ion source chamber 116. In at least one embodiment, the negative voltage pulse applied to the accelerator electrode 140 is of a higher amplitude than the negative voltage pulse applied to the ionization electrode 138. The ion accelerator 136 accelerates the ions toward an axis of the ion source chamber (e.g., axis 122) to form the plasma 138. The extraction ring 124 extracts the plasma 138 through the extraction aperture 126 to produce the ion beam 108. The voltage source 112 applies a voltage to the target rod 110, and the ions of the ion beam 108 are accelerated through the acceleration gap 144 toward the ion target 114 due to the electric field provided by the voltage source 112. In at least one example, the voltage multiplier 112 applies a voltage of at least 100 kilovolts (kV). The ion beam 108 collides with the ion target 114 to initiate the nuclear fusion reaction. In at least one embodiment, the ion beam 108 is a deuterium ion beam, and the ion target 114 is impregnated with deuterium atoms, such that the acceleration of the ion beam 108 into collision with the ion target 114, causes the neutron generator 100 to produce a deuterium-deuterium fusion reaction,

Some neutron generators of conventional design ionize deuterium gas inside a vacuum chamber by electron impact ionization, This can result in a delay (e.g., at least 1 μs, and often a few microseconds) between the application of the ion source voltage and the onset of plasma formation, contributing to increased ignition time of the ion source (often 5-10 μs). By using direct ionization, the neutron generator 100 can reduce the ion source ignition time, thus improving the transient characteristic of the device. For example, in at least one embodiment, the ignition time is less than about 1 μs.

Thus, in at least one embodiment, the neutron generator 100 includes a field ionization array 128 cylindrically distributed on the inner surface of the housing 102 of the neutron generator 100 for the production of at least 50% monatomic deuterium ions. In at least one embodiment, the neutron generator 100 has an ionization electrode 138 separate from the accelerator electrode 140 to optimize the production, extraction, and acceleration of deuterium ions inside the ion source chamber 116. In some embodiments, the neutron generator 100 has a turn-on/turn-off time delay of less than 1 μs. In at least one embodiment, the neutron generator 100 is a high output (e.g., greater than 10⁷ neutrons per second) of monoenergetic 2.5 MeV energy. In at least one embodiment, the neutron generator 100 has a neutron yield of approximately 10⁸ neutrons per second. In some embodiments, the neutron generator 100 includes a voltage source 112 for providing a voltage magnitude sufficient to initiate the deuterium-deuterium reaction. In at least one embodiment, the voltage source 122 comprises a high voltage multiplier capable of supplying at least 100 kV to accelerate the ion beam 108 toward the ion target 114. In at least one embodiment, the voltage source 112 is an ultra-high voltage multiplier.

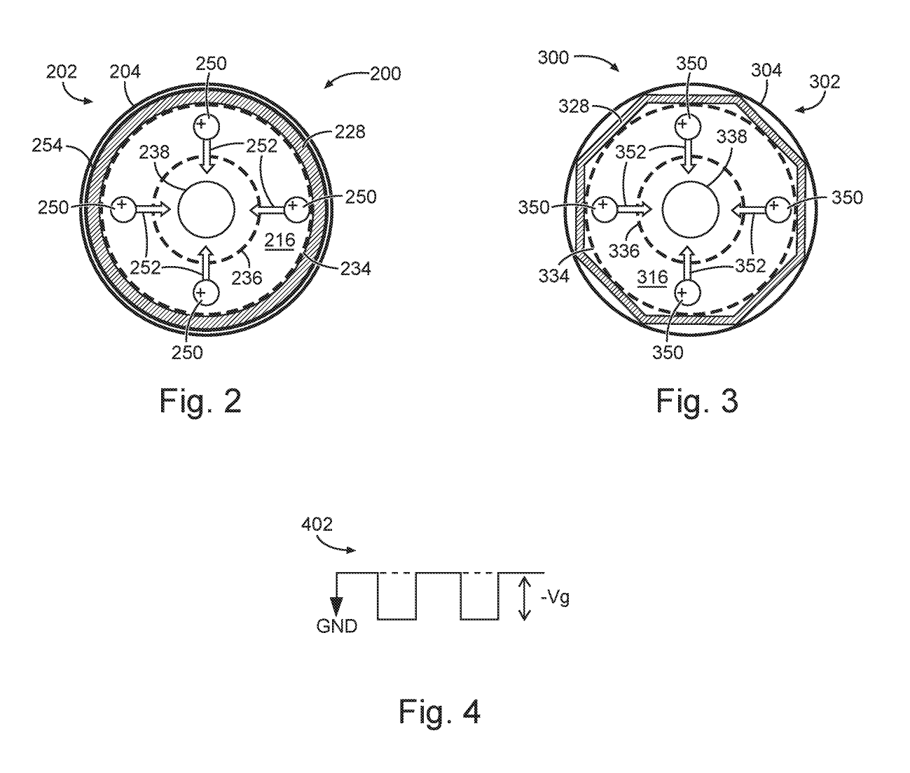

FIG. 2 is a cross-section view of a neutron generator 200 showing a field ionization array 228, in accordance with some embodiments. In the illustrated embodiment, the field ionization array 228 comprises a bundle of nanotips grown on a cylindrical substrate 254 that is concentric with a cylindrical tube 204 of a housing 202 of the neutron generator 200. Responsive to a voltage pulse, the field ionization array 228 and an ionization grid 234 produce deuterium ions 250 by direct ionization of the deuterium gas that is in close proximity to the nanotips of the field ionization array 128. Responsive to a voltage pulse applied to an ion accelerator grid 236, the deuterium ions 250 accelerate in the direction of arrows 252 toward a center axis of the ion chamber 216 to form plasma 238.

FIG. 3 is a cross-section view of a neutron generator 300 showing a field ionization array 328, in accordance with some embodiments. In the illustrated embodiment, the field ionization array 328 comprises a plurality of rectangular field ionization strips disposed on an interior surface of a cylindrical tube 304 of a housing 302 of the neutron generator 300. In at least one embodiment, the field ionization strips have manufacturing advantages over other options. Responsive to a voltage pulse, the field ionization array 328 and an ionization grid 334 produce deuterium ions 350 by direct ionization of the deuterium gas in close proximity to the nanotips of the field ionization array 328 in an ion chamber 316. Responsive to a voltage pulse applied to an ion accelerator grid 336, the deuterium ions 350 accelerate in the direction of arrows 352 toward a center axis of the ion chamber 316 to form plasma 338.

FIG. 4 depicts voltage pulses applied to a field ionization grid and an ion accelerator grid in accordance with some embodiments. For ease of understanding, FIG. 4 will be described with reference to the neutron generator 100 of FIG. 1. Diagram 402 illustrates an example pulsed voltage applied to the field ionization array 128 via the ionization electrode 138. A negative voltage pulse is applied to the ionization electrode 138 to cause the field ionization array 128 to produce charged particles for interaction with deuterium gas to produce deuterium ions in the ion source chamber 116.

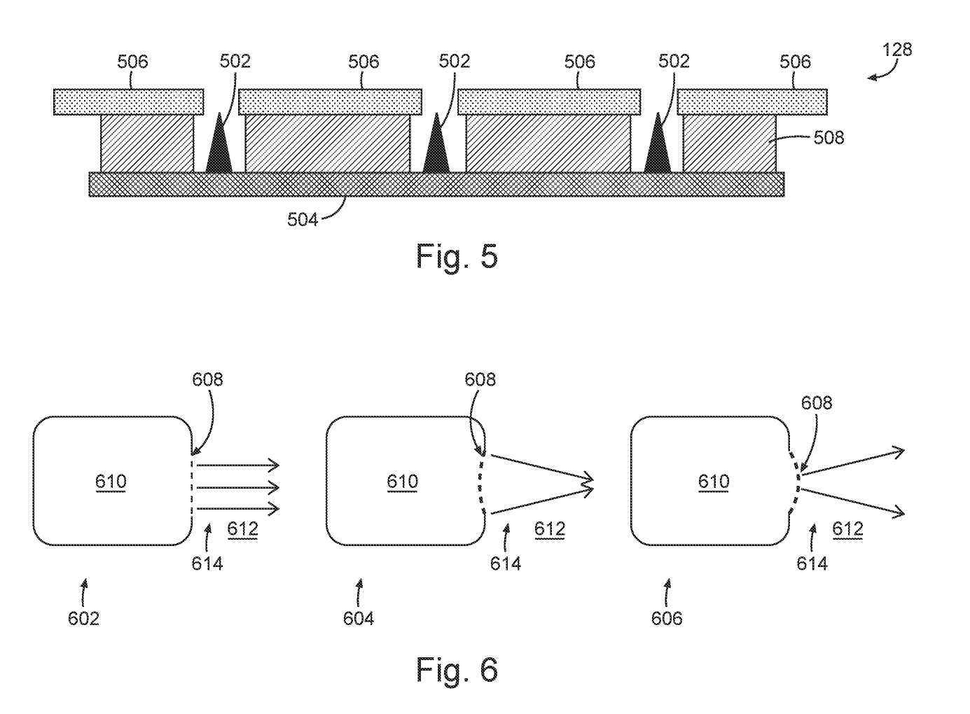

FIG. 5 shows a simplified axial section of a part of the field ionization array 128 of the example neutron generator 100 of FIG. 1. The field ionization array 128 comprises a multitude of nanotips 502 on the cylindrical substrate 504. In at least one embodiment, the nanotips 502 comprise tungsten formations attached to the substrate 504. In some embodiments, nanostructures providing the field ionization array 128 can comprise different shapes and can be of different materials. In at least one embodiment, the field ionization array 128 comprises carbon nanofibers. In some embodiments, each nanotip comprises a tungsten base tip attached to the substrate 504 and a carbon nanotip molecularly formed on the end of the tungsten base tip.

Each nanotip 502 projects away from the substrate 504. In some embodiments, each nanotip 502 is substantially perpendicular to the inner cylindrical surface of the substrate 504. Each nanotip 502 thus extends substantially radially inward toward the central longitudinal axis 122 of the ion chamber 116 (see, FIG. 1). In some embodiments, each nanotip 502 is roughly conical in shape, tapering to a tip end furthest from the substrate 504. In at least one embodiment, the length of each nanotip is less than 10 μm. In at least one embodiment, the length of each nanotip is approximately 2 μm. In some embodiments, the density of the nanotips 502 on substrate 504 is between 10⁴ and 10⁶ nanotips per square centimeter.

In some embodiments, the field ionization array 128 can include gate electrodes 506 interspersed between the nanotips 502 and spaced from the substrate 504 by insulators 508. In at least one embodiment, the spacing between the nanotips 502 and the gate electrodes 506 is selected such that pulses of ionization voltage between gate electrodes 506 and the nanotips 502 act to generate ions from the deuterium gas in the ion chamber 116 due to the operation of direct ionization.

During operation, field ionization nanotip array 128 is pulsed with negative voltage pulses at a predetermined repetition rate, via the ionization electrode 138 (see, FIG. 1). In at least one embodiment, the voltage pulse applied to the field ionization array 128 is approximately 1 kV, with a turn-on/turn-off time no greater than 1 μs. The voltage pulses applied to the field ionization array 128 cause production of predominantly monatomic deuterium ions at the outer radial periphery of the ion chamber 116, by operation of field ion emission. The predominantly monatomic deuterium ions are then accelerated radially away from the field ionization nanotip array via the ion accelerator grid 136 and the accelerator electrode 140, to form the plasma 138 for the ion beam 108 (see, FIG. 1).

FIG. 6 provides simplified example depictions 602, 604, 606 of plasma surface formation, according to some embodiments. The geometry of an extraction system (e.g. the extraction ring 124, extraction aperture 126, and the accelerating gap 144 of neutron generator 100 of FIG. 1) determines the transport characteristics of an ion beam 614. The design of an ion extraction system poses the challenge that the surface extraction from free plasmas changes according to a pressure of the plasma 610 and a current of the ion beam 614. The balance between the space-charge-limited current density jᵥ (density of the vacuum 612) given by Equation 1 and the plasma current density jₚ (of plasma 610) at the interface between the ion source and the accelerating vacuum region causes the plasma surface 608 to move along the extraction aperture axis in order to maintain the jᵥ-jₚ balance.

$${j}_{v} = \frac{4 {ɛ}_{0}}{9} \sqrt{\frac{2 e}{{m}_{i}}} \frac{{V}_{0}^{3 / 2}}{{d}^{2}} \qquad Equation 1$$

When the balance between the ion beam and vacuum current densities jᵥ-jₚ is altered the distance d of the plasma surface 608 (of plasma 610) changes in order to reach the balance jᵥ=jₚ. In example depiction 602, the plasma and vacuum current densities are equal (jₚ=jᵥ), and the plasma surface 608 causes the ion beam 614 to travel toward the ion target in an optimal configuration. In example depiction 604 the plasma current density is greater than the vacuum current density (jₚ>jᵥ), and the plasma surface 608 is concave causing the ion beam 614 to converge. In example depiction 606, the plasma current density is less than the vacuum current density (jₚ<jᵥ), and the plasma surface 608 is convex, causing the ion beam 614 to diverge.

It is therefore useful for the efficient operation of the ion source extraction and acceleration process of a neutron generator to have properly designed ion beam optics systems. Failure to do so can result in the creation of highly convergent or divergent beams detrimental to the optimal operation of a neutron generator.

In at least one embodiment, for a given geometry of the neutron generator, the size of the extraction aperture is selected such that the current provided by the neutron generator ion source is approximately equal to the current given by equation 1. In at least one embodiment, configuring the ion beam current and the current of equation 1 to match optimizes the ion beam extraction and transport. In at least one embodiment, configuring the two currents to be equal results in covering as much of the target surface as possible, reducing target temperature, reducing deuterium desorption, and increasing the neutron yield.

Further to the design and configuration of an extraction system, the extraction and accelerating regions of a neutron generator having a single mode of operation (sigma), and therefore one constant beam current, can be tailored to produce an ion beam of the required intensity of cross-sectional area approximately equal to the cross-sectional area of the ion target. This reduces target heating and increases neutron yield.

$${Y}_{n} = \frac{P \cdot {I}_{beam}}{e} \qquad Equation 2$$

Using Equation 2 for the neutron output, where P is the interaction probability, I_{beam} is the ion beam current impinging the target and e is the unit charge, an estimation of the neutron yield for the deuterium-deuterium neutron source (in accordance with some embodiments disclosed herein) gives Yₙ=1.61×10⁸ neutrons per second (n/s) where a value for P=2.59×10⁻⁷ has been used. A neutron yield of more than 10⁷ n/s is significant compared to the neutron yield of conventional deuterium-deuterium neutron generators (typically 10⁵-10⁷ n/s).

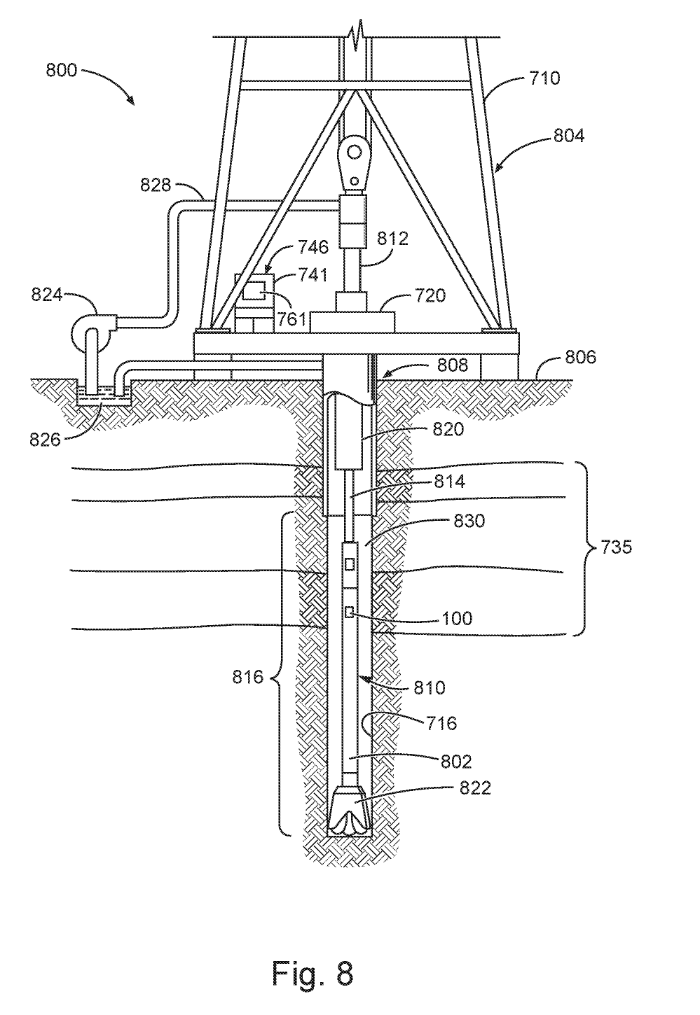

FIG. 7 is a diagram showing a wireline system 700 embodiment, and FIG. 8 is a diagram showing a logging while drilling (LWD) system 800 embodiment. The systems 700, 800 may thus comprise portions of a wireline logging tool body 705 as part of a wireline logging operation, or of a down hole tool 802 as part of a down hole drilling operation.

FIG. 7 illustrates a well used during wireline logging operations. In this case, a drilling platform is equipped with a derrick 710 that supports a hoist 715. Drilling oil and gas wells is commonly carried out using a string of drill pipes connected together so as to form a drillstring that is lowered through a rotary table 720 into a wellbore or borehole 716. Here it is assumed that the drillstring has been temporarily removed from the borehole 716 to allow a wireline logging tool body 705, such as a probe or sonde, to be lowered by wireline or logging cable 725 (e.g., slickline cable) into the borehole 716. Typically, the wireline logging tool body 705 is lowered to the bottom of the region of interest and subsequently pulled upward at a substantially constant speed. The tool body 705 may include neutron generator (which may include any one or more of the elements of FIGS. 1-6).

During the upward trip, at a series of depths various instruments (e.g., co-located with the neutron generator 100 included in the tool body 705) may be used to perform measurements on the subsurface geological formations 735 adjacent to the borehole 716 (and the tool body 705). The measurement data can be communicated to a surface logging facility 746 for processing, analysis, and/or storage. The processing and analysis may include natural gamma-ray spectroscopy measurements and/or determination of formation properties, for example, density or porosity. The logging facility 746 may be provided with electronic equipment for various types of signal processing. Similar formation evaluation data may be gathered and analyzed during drilling operations (e.g., during LWD/MWD (measurement while drilling) operations, and by extension, sampling while drilling).

In some embodiments, the tool body 705 is suspended in the wellbore by a wireline cable 725 that connects the tool to a surface control unit (e.g., comprising a workstation 741). The tool may be deployed in the borehole 716 on coiled tubing, jointed drill pipe, hard wired drill pipe, or any other suitable deployment technique.

Referring to FIG. 8, it can be seen how a system 800 may also form a portion of a drilling rig 804 located at the surface 806 of a well 808. The drilling rig 804 may provide support for a drillstring 810. The drillstring 810 may operate to penetrate the rotary table 720 for drilling the borehole 716 through the subsurface formations 735. The drillstring 810 may include a Kelly 812, drill pipe 814, and a bottom hole assembly 816, perhaps located at the lower portion of the drill pipe 814. As can be seen in the figure, the drillstring 810 may include a neutron generator 100 (which may include any one or more of the elements of FIGS. 1-6).

The bottom hole assembly 816 may include drill collars 820, a down hole tool 802, and a drill bit 822. The drill bit 822 may operate to create the borehole 716 by penetrating the surface 806 and the subsurface formations 735. The down hole tool 802 may comprise any of a number of different types of tools including MWD tools, LWD tools, and others. In other embodiments, the neutron generator 100 can be located anywhere along the drillstring 810, including as part of the downhole tool 802.

During drilling operations, the drillstring 810 (perhaps including the Kelly 812, the drill pipe 814, and the bottom hole assembly 816) may be rotated by the rotary table 720. Although not shown, in addition to, or alternatively, the bottom hole assembly 816 may also be rotated by a motor (e.g., a mud motor) that is located down hole. The drill collars 820 may be used to add weight to the drill bit 822. The drill collars 820 may also operate to stiffen the bottom hole assembly 816, allowing the bottom hole assembly 816 to transfer the added weight to the drill bit 822, and in turn, to assist the drill bit 822 in penetrating the surface 806 and subsurface formations 735.

During drilling operations, a mud pump 824 may pump drilling fluid (sometimes known by those of ordinary skill in the art as “drilling mud”) from a mud pit 826 through a hose 828 into the drill pipe 814 and down to the drill bit 822. The drilling fluid can flow out from the drill bit 822 and be returned to the surface 806 through an annular area 830 between the drill pipe 814 and the sides of the borehole 716. The drilling fluid may then be returned to the mud pit 826, where such fluid is filtered. In some embodiments, the drilling fluid can be used to cool the drill bit 822, as well as to provide lubrication for the drill bit 822 during drilling operations. Additionally, the drilling fluid may be used to remove subsurface formation cuttings created by operating the drill bit 822.

The workstation 741 and the controller 761 may include modules comprising hardware circuitry, a processor, and/or memory circuits that may store software program modules and objects, and/or firmware, and combinations thereof, as desired by the architect of the neutron generator 100 and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, and/or a combination of software and hardware used to simulate the operation of various potential embodiments.

Thus, many embodiments may be realized. Some of these will now be listed as non-limiting examples.

In some embodiments, a neutron generator comprises a housing to be incorporated in a subsurface logging tool, the housing defining an ion source chamber, a gas source to deliver ionizable gas to the ion source chamber, a field ionization array to directly ionize the ionizable gas to produce ions in the ion source chamber, and an extraction ring to produce an ion beam using the ions to initiate a fusion reaction that results in neutron emission from the neutron generator.

In some embodiments, the charged particles comprise deuterium ions.

In some embodiments the field ionization array is distributed along at least a portion of an inner surface of the housing.

In some embodiments, the field ionization array is distributed to at least partially surround a longitudinal axis of the housing.

In some embodiments, the neutron generator further comprises an ion target carrying target particles to form part of the fusion reaction in response to energetic impact of ions with the ion target, and a voltage source to accelerate the ions of the ion beam toward the ion target.

In some embodiments, the charged particles comprise deuterium ions and the target particles comprise deuterium atoms, such that the fusion reaction comprises a deuterium-deuterium fusion reaction.

In some embodiments, the neutron generator further comprises an ion accelerator to accelerate the ions toward an axis of the ion source chamber, an ionization electrode electrically coupled to a power source to control power distribution to the field ionization array, and an accelerator electrode electrically coupled to the power source to control power distribution to the ion accelerator.

In some embodiments, the neutron generator further comprises an ion target carrying target particles to form part of the fusion reaction in response to energetic impact of ions with the ion target, wherein the extraction ring is to extract the ions from the ion source chamber for acceleration toward the ion target, the extract ring comprising an extraction aperture dimensioned to produce an ion beam of cross-sectional area approximately equal to the cross-sectional area of the ion target.

In some embodiments, the neutron generator further comprises a voltage multiplier to supply at least 100 kilovolts (kV) to the neutron generator.

In some embodiments, the neutron generator does not use a chemical radioactive source.

In some embodiments, a turn-on/turn-off delay for the neutron generator is less than 1 μs.

In some embodiments, a method comprises delivering an ionizable gas to an ion source chamber defined by a neutron generator housing, producing ions, at a field ionization array, by direct ionization of the ionizable gas in the ion source chamber, to produce ions in the ion source chamber, extracting the ions from the ion source chamber to produce an ion beam, and producing a fusion reaction with the ion beam that results in neutron emission from the neutron generator.

In some embodiments, causing ion production in the ion source chamber comprises producing deuterium atomic ions.

In some embodiments, producing the fusion reaction that results in the neutron emission from the neutron generator comprises applying deuterium atomic ions to a deuterium-impregnated target to cause a deuterium-deuterium fusion reaction.

In some embodiments, producing the fusion reaction that results in the neutron emission from the neutron generator comprises generating greater than 10⁷ neutrons per second.

In some embodiments, producing the fusion reaction that results in the neutron emission from the neutron generator comprises generating monochromatic 2.5 megaelectron volt (MeV) neutrons.

In some embodiments, the method further comprises performing formation sigma measurements using the neutron emission.

In some embodiments, a subsurface logging tool comprises a body configured to move freely within a borehole, a neutron generator housed by the body, the neutron generator to generate and emit energetic neutrons, the neutron generator comprising a housing defining an ion source chamber, a gas source to deliver ionizable gas to the ion source chamber, a field ionization array directly ionize the ionizable gas to produce ions in the ion source chamber, and an extraction ring to produce an ion beam with the ions to initiate a fusion reaction that results in neutron emission from the neutron generator.

In some embodiments, the subsurface logging tool comprises an outside diameter of approximately 1.69 inches (4.29 centimeters) or less.

In some embodiments, the field ionization array is to generate at least 50% monatomic deuterium ions.

In some embodiments, the subsurface logging tool further comprises a voltage multiplier to supply at least 100 kilovolts (kV) to the neutron generator.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A neutron generator, comprising:
a housing defining an ion source chamber;
a gas source to deliver ionizable gas to the ion source chamber;
a field ionization array to directly ionize the ionizable gas to produce ions in the ion source chamber; and
an extraction ring to produce an ion beam using the ions to initiate a fusion reaction that results in neutron emission from the neutron generator.

2. The neutron generator of claim 1, wherein the ions comprise deuterium ions.

3. The neutron generator of claim 1, wherein the field ionization array is distributed along at least a portion of an inner surface of the housing.

4. The neutron generator of claim 1, wherein the field ionization array is distributed to at least partially surround a longitudinal axis of the housing.

5. The neutron generator of claim 1, further comprising:
an ion target carrying target particles to form part of the fusion reaction in response to energetic impact of ions with the ion target; and
a voltage source to accelerate the ions of the ion beam toward the ion target.

6. The neutron generator of claim 5, wherein the ions comprise deuterium ions and the target particles comprise deuterium atoms, such that the fusion reaction comprises a deuterium-deuterium fusion reaction.

7. The neutron generator of claim 5, further comprising:
an ion accelerator to accelerate the ions toward an axis of the ion source chamber;
an ionization electrode electrically coupled to a power source to control power distribution to the field ionization array; and
an accelerator electrode electrically coupled to the power source to control power distribution to the ion accelerator.

8. The neutron generator of claim 1, further comprising:
an ion target carrying target particles to form part of the fusion reaction in response to energetic impact of ions with the ion target; and
wherein the extraction ring is to extract the ions from the ion source chamber for acceleration toward the ion target, the extract ring comprising an extraction aperture dimensioned to produce an ion beam of cross-sectional area approximately equal to the cross-sectional area of the ion target.

9. The neutron generator of claim 1, further comprising:
a voltage multiplier to supply at least 100 kilovolts (kV) to the neutron generator.

10. The neutron generator of claim 1, wherein the neutron generator does not use a chemical radioactive source.

11. The neutron generator of claim 1, wherein a turn-on/turn-off delay for the neutron generator is less than 1 μs.

12. A method, comprising:
delivering an ionizable gas to an ion source chamber defined by a neutron generator housing;
producing ions, at a field ionization array, by direct ionization of the ionizable gas in the ion source chamber;
extracting the ions from the ion source chamber to produce an ion beam; and
producing a fusion reaction with the ion beam that results in neutron emission from the neutron generator.

13. The method of claim 12, wherein causing ion production in the ion source chamber comprises producing deuterium atomic ions.

14. The method of claim 12, wherein producing the fusion reaction that results in the neutron emission from the neutron generator comprises applying deuterium atomic ions to a deuterium-impregnated target to cause a deuterium-deuterium fusion reaction.

15. The method of claim 12, wherein producing the fusion reaction that results in the neutron emission from the neutron generator comprises generating greater than 10⁷ neutrons per second.

16. The method of claim 12, wherein producing the fusion reaction that results in the neutron emission from the neutron generator comprises generating monochromatic 2.5 megaelectron volt (MeV) neutrons.

17. The method of claim 12, further comprising:
performing formation sigma measurements using the neutron emission.

18. A subsurface logging tool comprising:
a body configured to move freely within a borehole;
a neutron generator housed by the body, the neutron generator to generate and emit energetic neutrons, the neutron generator comprising:
a housing defining an ion source chamber;
a gas source to deliver ionizable gas to the ion source chamber;
a field ionization array to directly ionize the ionizable gas to produce ions in the ion source chamber; and
an extraction ring to produce an ion beam with the ions to initiate a fusion reaction that results in neutron emission from the neutron generator.

19. The subsurface logging tool of claim 18, wherein the subsurface logging tool comprises an outside diameter of approximately 1.69 inches (4.29 centimeters) or less.

20. The subsurface logging tool of claim 18, wherein the field ionization array is to generate at least 50% monatomic deuterium ions.

21. The subsurface logging tool of claim 18, further comprising:
a voltage multiplier to supply at least 100 kilovolts (kV) to the neutron generator.
